(19) United States
(12) Patent Application Publication
(10) Pub. No.: US 2024/0002683 A1
(43) Pub. Date: Jan. 4, 2024

(54) FORMALDEHYDE-SCAVENGING FORMULATION

(71) Applicant: Owens Corning Intellectual Capital, LLC, Toledo, OH (US)

(72) Inventors: Camille ROUILLON, Bassens (FR); Carl Alain Dominique DESAINTJEAN, Saint Pierre d'Albigny (FR); Marc COSSEMENT, Polleur (BE); Paul A. GEEL, Heveadorp (NL)

(21) Appl. No.: 18/252,758

(22) PCT Filed: Nov. 17, 2021
(86) PCT No.: PCT/IB2021/060647

§ 371 Date: May 12, 2023

(30) Foreign Application Priority Data
Nov. 17, 2020 (EP) 20208236.8

(51) Int. Cl. C09D 7/65; C09D 133/04; C09D 5/18; C09D 7/45; C09D 7/61; E04C 2/52; B32B 21/10; B32B 5/02; D04H 1/4218

(52) U.S. Cl. CPC C09D 7/65; D10B 2505/00; C09D 5/18; C09D 7/45; C09D 7/61; E04C 2/526; B32B 21/10; B32B 5/022; D04H 1/4218; B32B 2255/02; B32B 2255/26; B32B 2307/3065; B32B 2250/40; B32B 2307/7242; B32B 2607/00; B32B 2262/101; C09D 133/04

(57) ABSTRACT

The present invention is concerned with improved formaldehyde-scavenging formulations, and uses of same in veils and construction products including ceiling tiles, boards including insulation boards, particularly phenolic insulation boards, and panels and boards including wood panels and wood boards, together with methods for reduction of formaldehyde emissions from a construction product.

### FIELD OF THE INVENTION

The present invention is concerned with improved formaldehyde-scavenging formulations, and uses of same. Particular uses include in veils (particularly non-woven veils) and construction products including ceiling tiles, boards including insulation boards, particularly phenolic insulation boards, and panels and boards including wood based panels, fabrics, textiles, and on or applied to other substrates. Also disclosed is methods for reduction of formaldehyde emissions from a construction product.

### BACKGROUND TO THE INVENTION

Formaldehyde has a high potential toxicity and is an irritant that may cause allergic reactions and other health issues, including irritation of the skin, of the respiratory tract or of the eyes in humans. The publication “WHO Guidelines for Indoor Air Quality: Selected Pollutants” (World Health Organization, 2010, ISBN 978 92 890 0213 4, pp. 103-156) further details the health impact of formaldehyde. Golden, R. (Crit Rev Toxicol. 2011 September; 41(8): 672-721; doi: 10.3109/10408444.2011.573467; PMID: 21635194) provides a recommendation for an indoor air exposure limit for formaldehyde.

Emission standards are set by various national laws, including French law Dëcret no 2011-321 (published 25 Mar. 2011). Emissions classes in France are defined in the JOURNAL OFFICIEL DE LA RÉPUBLIQUE FRANÇAISE, JORF no 0111, 13 May 2011, NOR: DEVL1104875A at Annex I.D—the “Arrêté étiquetage 2011”). Class “A+” for VOC (volatile organic compounds) emissions includes a requirement for <10 ug/m\hat{ }3 of formaldehyde emissions in 28 days. Class “A” for VOC emissions includes a requirement for <60 ug/m\hat{ }3 of formaldehyde emissions in 28 days.

Formaldehyde emissions from construction products therefore have to be controlled/reduced in order to minimise health risk and comply with standards. The reduction of formaldehyde emissions from construction products is therefore important.

It is also highly desirable that any new or improved formaldehyde-scavenging agent or composition (i.e. formulation) (i) does not itself present additional environmental or health and safety concerns, including in a manufacturing environment, and (ii) is compatible with existing construction product manufacturing protocols and process conditions so that a switch of formaldehyde-scavenging agent or composition (i.e. formulation) can be made without having to modify existing construction product manufacturing protocols and process conditions.

JP2009274409A discloses a facer material comprising a flame retardant and a formaldehyde scavenger.

CN106346568A discloses a flame-retardant composite urea-formaldehyde resin.

Ghani, A. et al (June 2018, Building and Environment 142, doi: 10.1016/j.buildenv.2018.06.020) discloses reducing formaldehyde emission of urea formaldehyde-bonded particleboard by addition of amines as formaldehyde scavenger.

WO 2006/007168 discloses fibrous veils impregnated with a surface finish formulation.

CA2657108 (=WO 2008/012113) discloses the use of timber materials comprising polyamine for lowering formaldehyde content in ambient air.

US 2010/0190021 (U.S. Pat. No. 8,460,761) discloses a method for the reduction of formaldehyde emission in wood-base materials by treatment with polyamines.

Other publications include EP3415475 (US2010282996), U.S. Pat. No. 3,702,798, U.S. Ser. No. 10/035,913, WO2006104455, and WO2019133463.

The present invention seeks to overcome one or more of the prior art disadvantages and provide improved formaldehyde-scavenging formulation.

### SUMMARY OF THE INVENTION

According to the present invention there is provided a formaldehyde-scavenging formulation comprising:
(a) formaldehyde scavenger (1-90% by weight dry mass), wherein the formaldehyde scavenger is polyvinylamine or a copolymer thereof, and/or a primary amine functionalised silane;
(b) binder and/or crosslinker (0-60% by weight dry mass);
(c) antifoaming agent (<0.5% by weight dry mass);
(d) base (0-50% by weight dry mass);
(e) fire retardant (0-96% by weight dry mass); and
(f) repellent agent (<2% by weight dry mass).

In particular, the formaldehyde scavenger may be polyvinylamine.

The polyvinylamine may be present in forms other than a pure polyvinylamine. It may, for example, be present in the form of a copolymer, for example a polyvinylamine-polyvinyl alcohol (PVAm-PVOH) copolymer.

As can be seen from the specific embodiments (below), (a) the formaldehyde scavenger, (b) the binder and/or crosslinker, and (c) the antifoaming agent are present in all embodiments of the invention (Examples 1-7 and 9). Thus, the binder and/or crosslinker can be present in a quantity <=60%. Thus, the quantity of binder and/or crosslinker can be greater than 0% and less than or equal to 60%.

Similarly, the antifoaming agent is present in all embodiments, and in a quantity <0.5%. Thus, the quantity of antifoaming agent can be expressed as being greater than 0% and less than 0.5%.

As can be seen from the specific embodiments, the base, fire retardant, and repellent are each absent from one or more embodiment. Thus, the formulation can comprise at least one of:
(d) base (<=50% by weight dry mass);
(e) fire retardant (<=96% by weight dry mass); and
(f) repellent agent (<2% by weight dry mass).

In particular embodiments, the formulation comprises base (<=50% by weight dry mass).

In certain embodiments, two of (d), (e) and (f) are present. Thus, in certain embodiments, the formulation comprises at least two of:
(d) base (<=50% by weight dry mass);
(e) fire retardant (<=96% by weight dry mass); and
(f) repellent agent (<2% by weight dry mass).

In particular embodiments, the formulation comprises both base and fire retardant.

In certain embodiments, all three of (d), (e) and (f) are present. Thus, in certain embodiments, the formulation comprises all three of:
(d) base (<=50% by weight dry mass);
(e) fire retardant (<=96% by weight dry mass); and
(f) repellent agent (<2% by weight dry mass).

The formulation may optionally additionally comprise one or more of:
(A) dispersing agent;
(B) viscosity modifier; and
(C) polyphosphate sodium salts (NaPO₃)ₙ.

In certain embodiments, the formulation comprises dispersing agent (<3% by weight dry mass).

In certain embodiments, the formulation comprises viscosity modifier (<3% by weight dry mass).

In certain embodiments, the formulation comprises polyphosphate sodium salts (NaPO₃)ₙ (<10% by weight dry mass).

In certain embodiments, the formulation additionally comprises pigment. In particular embodiments, it comprises <5% by weight dry mass of pigment. Pigment can be particularly useful to hide or mask discoloration resulting from e.g. heat impact from subsequent processing/use of the formulation. For example, a black pigment is used in certain embodiments to hide discoloration resulting from subsequent heating of the formulation.

As detailed in the Examples below, the formulations of the present invention are particularly good at achieving formaldehyde-scavenging.

The formaldehyde-scavenging formulation is typically an aqueous formulation.

Particular formaldehyde-scavenging formulations include:

Phosphorous-Nitrogen (P—N) fire retardant formulation—this formulation includes the formulations used in Example 1. This formulation comprises:
formaldehyde scavenger (1-50% by weight dry mass), wherein the formaldehyde scavenger is polyvinylamine;
binder and/or crosslinker (0-20% by weight dry mass);
antifoaming agent (<0.5% by weight dry mass);
fire retardant (50-96% by weight dry mass), wherein the fire retardant is a phosphorous-nitrogen fire retardant; and
repellent agent (<2% by weight dry mass).

As noted above, (a) the formaldehyde scavenger, (b) the binder and/or crosslinker, and (c) the antifoaming agent are present in all embodiments. Thus, in the case of this P—N fire retardant formulations, the binder and/or crosslinker can be present in a quantity <=20%. Thus, the quantity of binder and/or crosslinker can be greater than 0% and less than or equal to 20%. Similarly, the antifoaming agent is present in a quantity <0.5%. Thus, the quantity of antifoaming agent can be expressed as being greater than 0% and less than 0.5%.

As can be seen from Example 1, binder and/or crosslinker is present, i.e. the amount of binder and/or crosslinker can be expressed as being <=20%. Thus, there is greater than 0% and less than or equal to 20% binder and/or cross-linker.

In certain embodiments of the P—N fire retardant formulation, the amount of binder and/or crosslinker is <=15% (i.e. greater than 0% and <=15%). In certain embodiments of the P—N fire retardant formulation, the amount of binder and/or crosslinker is <=10%. In certain embodiments of the P—N fire retardant formulation, the amount of binder and/or crosslinker is <=8.0%.

In Example 1, base is not present.

As noted below, in certain embodiments, base is also included, particularly to prevent agglomeration.

ATH (aluminium trihydrate) fire-retardant formulation—this formulation includes the formulations used in Examples 2-6 (below). This formulation comprises:
formaldehyde scavenger (1-50% by weight dry mass), wherein the formaldehyde scavenger is polyvinylamine;
binder and/or crosslinker (0-20% by weight dry mass);
antifoaming agent (<0.5% by weight dry mass);
base (0-12.5% by weight dry mass);
fire retardant (50-96% by weight dry mass), wherein the fire retardant is an aluminium trihydrate fire retardant; and
repellent agent (<2% by weight dry mass).

The pH of the formulation may be between 9.5 and 10.5.

In certain embodiments where the formulation includes base, the dry weight ratio of formaldehyde scavenger to base is in the range 1:1 to 2:1.

As noted above, (a) the formaldehyde scavenger, (b) the binder and/or crosslinker, and (c) the antifoaming agent are present in all embodiments. Thus, in the case of the ATH fire retardant formulations, the binder and/or crosslinker can be present in a quantity <=20%. Thus, the quantity of binder and/or crosslinker can be greater than 0% and less than or equal to 20%. Similarly, the antifoaming agent is present in a quantity <0.5%. Thus, the quantity of antifoaming agent can be expressed as being greater than 0% and less than 0.5%.

In each of Examples 2-6, binder and/or crosslinker is present, i.e. there is greater than 0% and less than or equal to 20% binder and/or cross-linker.

In each of Examples 2-6, base is present, as is fire retardant. Thus, in certain embodiments both base and fire retardant are present. Thus, in certain embodiments the amount of base can be expressed as being in the amount <=12.5%, i.e. greater than 0% and <=12.5%. As above, the amount of fire retardant can be expressed as being in the range 50-96%.

Repellent agent is not present in Examples 3, 4 or 6. Thus, the repellent agent is optional in the ATH formulations.

PVAm-Acrylic formulation—this formulation includes the formulation used in Example 7. This formulation comprises:
formaldehyde scavenger (10-90% by weight dry mass), wherein the formaldehyde scavenger is polyvinylamine;
binder and/or crosslinker (0-50% by weight dry mass);
antifoaming agent (<0.5% by weight dry mass); and
base (0-25% by weight dry mass).

As noted above, (a) the formaldehyde scavenger, (b) the binder and/or crosslinker, and (c) the antifoaming agent are present in all embodiments. Thus, in the case of the PVAm-acrylic formulations, the binder and/or crosslinker can be present in a quantity <=50%. Thus, the quantity of binder and/or crosslinker can be greater than 0% and less than or equal to 50%. Similarly, the antifoaming agent is present in a quantity <0.5%. Thus, the quantity of antifoaming agent can be expressed as being greater than 0% and less than 0.5%.

As can be seen from Example 7, binder and/or crosslinker is present, i.e. the amount of binder and/or crosslinker can be expressed as being <=50%.

In Example 7, base is present, i.e. the amount of base can be expressed as being <=25%.

Thus, embodiments comprising polyvinylamine as the formaldehyde scavenging agent can additionally comprise base. In certain embodiments comprising polyvinylamine as the formaldehyde scavenger, they comprise base in an amount <=25%.

### Formaldehyde Scavenger

Typically, the polyvinylamine (PVAm) has a weight average molecular weight (Mw) in the range 50,000-800,000 g/mol, 200,000-600,000 g/mol, more typically 300,000-500,000 g/mol, more typically approximately 400,000 g/mol.

In certain embodiments, the percentage dry weight of polyvinylamine is in the range 1-60%, more typically 1-45%. In certain embodiments, it is in the range 1-30%. In other embodiments, it is in the range 5-30%. In other embodiments, it is in the range 1-15%. In certain embodiments, it is in the range 2-11%. In some embodiments, it is in the range 2.5-7%. In some embodiments, it is in the range 3-5%.

In embodiments comprising a fire retardant, the total percentage dry weight of the fire retardant and formaldehyde scavenger may be at least 50%. In certain embodiments, it is at least 60%. In other embodiments, it is at least 70%. In further embodiments, it is at least 80%. In certain embodiments, it is at least 90%. In other embodiments, it is at least 95%. In certain embodiments, it is at least 96%.

In embodiments comprising fire retardant, the dry weight ratio of fire retardant to formaldehyde scavenger may be at least 2:1. It may be at least 3:1. It may be at least 4:1. It may be at least 5:1. It may be at least 10:1. It may be at least 15:1. It may be at least 20:1. It may be at least 25:1.

The percentage dry weight of formaldehyde scavenger in the formulation can vary significantly according to the intended use of the formulation, particularly the product to which the formulation is to be used on, in or with, e.g. applied to or used in.

Binder and/or Crosslinker

Binders include the likes of styrene-acrylic ester copolymers, acrylic, ethylene-vinyl acetate (EVA), polyvinyl alcohol (PVOH/PVA), polyurethane (PU), polyester, polyvinylpyrrolidone (PVP) and starch derivatives. Water-based polymer emulsions or solutions or mixtures of both are particularly preferred. An exemplary binder is an aqueous dispersions of a styrene-acrylic ester copolymer with silanol functionalities.

Suitable crosslinkers include blocked isocyanate crosslinkers such as water-based blocked polyisocyanates.

In certain embodiments, the binder and/or crosslinker is in the form of binder, the percentage dry weight of binder being in the range 1-60%. In certain such embodiments, the percentage dry weight of binder is in the range 1-40%. In other such embodiments, it is in the range 5-35%.

In alternative embodiments, the binder and/or crosslinker is in the form of crosslinker, the percentage dry weight of crosslinker being in the range 1-10%. In certain such embodiments, it is in the range 2-9%. In other such embodiments, it is in the range 3-8%. In other such embodiments, it is in the range 4-7%. In further embodiments, it is in the range 5-6%.

In some embodiments, both binder and crosslinker are present. In certain embodiments, the total percentage dry weight of binder and crosslinker is in the range 1-15%, more typically 3-12%, more typically 5-9%. The dry weight ratio of binder to crosslinker in certain such embodiments is in the range 2:1 to 20:1. In certain embodiments, the ratio is in the range 5:1 to 15:1. In other embodiments, the ratio is in the range 8:1 to 12:1. In particular embodiments, the ratio is approximately 10:1.

As can be seen from the above discussion of binders and/or crosslinkers and the various specific embodiments below, the binder and/or crosslinker is present in all embodiments. Thus, the range for the binder and/or crosslinker can be expressed as being <=60%.

As can be seen from the above optional ranges for (i) the binder, (ii) the crosslinker, and (iii) the binder plus crosslinker combinations, the overall range can be expressed as being at least 1% binder and/or crosslinker, i.e. the binder and/or crosslinker is present in the range 1-60%.

### Antifoaming Agent

Antifoam agents are well known in the art. Suitable antifoam agents include (but are not limited to) those based on polydimethylsiloxane (PDMS) oils and emulsions.

In certain embodiments, there is <0.1% antifoam agent present. In certain embodiments, there is <=0.05% antifoam agent. In certain embodiments, the amount of antifoam agent is >=0.01% and <0.1%. In certain embodiments, the amount of antifoam agent >=0.01% and <=0.05% is In certain embodiments, there is between 0.01% and 0.02% antifoam agent.

### Base

Suitable bases will be readily apparent to one of ordinary skill in the art and include (but are not limited to) Ca(OH)₂, NaOH, KOH, Na₂CO₃, Mg(OH)₂, and Na₃PO₄. A particular preferred base is sodium carbonate (Na₂CO₃).

In certain embodiments, the percentage dry weight of base is in the range 0-25%. Thus, in embodiments comprising base, it can be present in an amount <=25%. In other embodiments, it is in the range 0.5-25%. In other embodiments, it is in the range 1-20%. In other embodiments, it is in the range 1.5-15%.

In embodiments comprising base, the dry weight ratio of polyvinylamine to base may be in the range 1:3 to 3:1. It may be in the range 1:2 to 2:1. It may be in the range 1:1 to 2:1.

Base is particularly useful in preventing agglomeration. It is desirable to reduce, minimise or avoid agglomeration entirely since it can have undesired effects. In particular, it can e.g. result in clogged filters when they are used as part of the manufacturing process. Similarly, agglomeration can result in undesirable textural effects/lumps in the final product.

In particular, agglomeration can result from e.g. the formaldehyde scavenger reacting with/having affinity for carboxylic groups and/or trialkoxysilane groups. For example, carboxylic groups can be present as sodium polycarboxylic acid and citric acid in dispersants present in components (e.g. ATH fire retardants or P—N fire retardants) used in the formulation.

Further experiments undertaken with the formulation of Example 1 (below), which does not comprise any base, showed that it was prone to agglomeration. Additional experiments (not detailed) have shown that the addition of base (in the form of Na₂CO₃) to the formulation used in Example 1 prevented agglomeration from occurring.

Similarly, additional experiments with formulations comprising trialkoxysilane and no base have found that agglomeration can occur. Additional experiments incorporating base int eh formulation have resulted in agglomeration being prevented.

Agglomeration was not observed with the formulations of Examples 2-7 or 9.

Thus, in certain embodiments, the formulation comprises base.

Thus, in embodiments where the formulation comprises carboxylic acid/polycarboxylic acid, the formulation can comprise base. Similarly, in embodiments where the formulations comprises trialkoxysilane, the formulation can comprise base.

In particular, base can be present in the formulation to pre-empt possible agglomeration.

### Fire Retardant

Suitable fire retardants include (but are not limited to) aluminium trihydrate (ATH) and phosphorous nitrogen (P—N) fire retardants.

### Repellent Agent

The repellent agent water and/or oil repellent. Suitable repellents include (but are not limited to) fluorocarbons and perfluoroalkyl-functionalized acrylates.

### Dispersing Agents

Suitable dispersing agents include (but are not limited to) polycarboxylic acid dispersants, particularly salt solutions such as sodium salt solutions of polycarboxylic acid dispersants.

### Additive

In particular, additives may comprise polyphosphate sodium salts (NaPO₃)ₙ.

### Uses

The formaldehyde scavenging formulations of the present invention can be used in (e.g. applied to, or contained in) veils (particularly non-woven veils) and construction products including ceiling tiles, boards including insulation boards, particularly phenolic insulation boards, and panels and boards including wood based panels, fabrics, textiles, and on or applied to other substrates.

### Veils

Also provided according to the present invention is a non-woven veil coated with or containing a formaldehyde-scavenging formulation according to the present invention.

Also provided according to the present invention is a non-woven veil coated with or containing an aminosilane or an amino-precursor group functionalised silane. As shown in the examples below, aminosilane is an effective formaldehyde scavenger. The aminosilane may be in the form of a formaldehyde-scavenging formulation, for example comprising the aminosilane and water. Typically, the aminosilane is a primary aminosilane, i.e. a primary amine functionalised silane. An exemplary aminosilane is gamma-aminopropyltriethoxysilane (H₂NCH₂CH₂CH₂Si(OCH₂CH₃)₃).

Non-woven veils for construction products are well known in the art, and typically comprise intermingled, randomly oriented reinforcing fibres. The fibre component of a veil may be any of metal fibres, ceramic fibres, mineral fibres, glass fibres, carbon fibres, graphite fibres, polymer fibres, such as aramid, polyesters, polyacrylics, polyamides, polyacrylonitrile, natural fibres and combinations thereof. In particular, the fibre component of the veil may be glass fibres. The veil may comprise 20-130 g/m\hat{ }2 of fibres.

The veil may comprise up to 40 g/m\hat{ }2 of formaldehyde scavenger. It may comprise 0.5-20 g/m\hat{ }2 of formaldehyde scavenger. It may comprise 1-15 g/m\hat{ }2 of formaldehyde scavenger. It may comprise 2-10 g/m\hat{ }2 of formaldehyde scavenger. It may comprise 3-6 g/m\hat{ }2 of the formaldehyde scavenger. As detailed in the examples below, excellent results have been achieved with these quantities of formaldehyde scavenger.

In particular, the veil may comprise 5-250 g/m\hat{ }2 of the formaldehyde-scavenging formulation, of which is formaldehyde scavenger.

### Construction Products

Also provided according to the present invention is a construction product having a non-woven veil according to the present invention on at least one surface. Exemplary construction products include ceiling tiles, wall panels, insulation boards, gypsum boards, and wood based panels. In particular, the construction product may have a non-woven veil according to the present invention on at least one of a front face and a back face. The construction product may be made of a wool such as a glass, rock, stone or mineral wool. Products including wood based panels include, but are not limited to, floor tiles and furniture. Ceiling tiles include, but are not limited to, wet felt boards.

In the case of a ceiling tile, it may have a non-woven veil according to the present invention on at least one of its front and back faces. The ceiling tile may contain a formaldehyde emissive binder. The ceiling tile may be made of wool. The wool may be a glass, rock, stone or mineral wool.

In the case of a wall panel, it may have a non-woven veil according to the present invention on at least one of its front and back faces. The wall panel may contain a formaldehyde emissive binder. The ceiling tile may be made of wool. The wool may be a glass, rock, stone or mineral wool.

In the case of an insulation board, it may have a non-woven veil according to the present invention on at least one of its front and back faces. The insulation board may be a phenolic foam board, or a mineral wool board.

In the case of a wood based panel (WBP), it may have a non-woven veil according to the present invention on at least one of its front and back faces, or contained in a laminate.

Where the construction product is a wood based panel, the percentage dry weight of formaldehyde scavenger in the formaldehyde-scavenging formulation may be in the range 10-40%. In certain such embodiments, it is in the range 15-35%. In other such embodiments, it is in the range 20-30%. In certain such embodiments where the formulation also comprises a fire retardant, the dry weight ratio of fire retardant to formaldehyde scavenger may be in the range 5:1 to 2:1

Where the construction product is a ceiling tile or wall panel, the percentage dry weight of formaldehyde scavenger in the formaldehyde-scavenging formulation may be in the range 2-11%. In certain such embodiments, it may be in the range 3-6%. In certain such embodiments where the formulation also comprises a fire retardant, the dry weight ratio of fire retardant to formaldehyde scavenger may be at least 10:1. In certain such embodiments, it is at least 15:1. In certain such embodiments, it is at least 20:1. In other such embodiments, it is at least 25:1.

Where the construction product is an insulation board such as a phenolic insulation board, the percentage dry weight of formaldehyde scavenger may be in the range 1-20%. In certain embodiments, it is in the range 5-15%. In particular embodiments, it is in the range 7.5-12.5%. In certain such embodiments where the formulation also comprises a fire retardant, the dry weight ratio of fire retardant to formaldehyde scavenger may be in the range 2:1 to 10:1. In certain such embodiments, it is in the range 3:1 to 9:1. In certain such embodiments, it is in the range 4:1 to 8:1.

Also provided according to the present invention is a method of reducing formaldehyde emissions from a construction product, the method comprising the step of attaching a non-woven veil according to the present invention to at least one outer surface of the construction product.

The at least one outer surface may be an at least one major surface of the product, for example a front surface, or both a front surface and a rear surface. Examples of construction products are tiles (for example, ceiling tiles) and panels and boards (for example, wall panels, ceiling panels, and insulation boards).

The term “comprising” as used herein to specify the inclusion of components also includes embodiments in which no further components are present.

Embodiments of the invention will now be described, by way of example only.

### DETAILED DESCRIPTION

The % by weight values used throughout the specification are based on the total dry weight.

In the following examples, formaldehyde-scavenging formulations and construction products according to the present invention show excellent results.

### Example 1

In this example, a wood based panel (WBP) was used as a formaldehyde emission source. The rear side and edges of the panel were covered with a non-emissive aluminium tape (except for “WBP+Recipe 1/×25g 2 sides” where the rear side was instead covered with a scavenging veil). The emitting surface was about 0.06 m\hat{ }2 in a 51 L chamber. Formaldehyde concentrations (μg/m\hat{ }3) are given as estimation in the European standard room, considering Ceiling loading factor.

The “Recipe 1” scavenger formulation used on the scavenging veils was:

| Category | Solids (%) | Kg wet | % dry |
|---|---|---|---|
| anti-foam | 0.5% | 2.0 | 0.01% |
| PN fire retardant | 50.0% | 149.9 | 65.59% |
| scavenger (PVAm) | 21.0% | 149.9 | 27.55% |
| repellent | 30.0% | 3.6 | 0.94% |
| cross-linker | 45.0% | 15.0 | 5.90% |

### Samples:

Wood Based Panel (WBP): unfaced wood panel
WBP+NS Veil: wood panel+1 non-scavenging veil applied on the surface
WBP+Recipe 1/x12g: wood panel+1 scavenging veil (12 g/m² add-on, meaning 3.3 g/m² PVAm)
WBP+Recipe 1/x25g: wood panel+1 scavenging veil (25.7 g/m² add-on, meaning 7.1 g/m² PVAm)
WBP+Recipe 1/x25g 2 sides: wood panel+1 scavenging veil on the front side+1 scavenging veil on the rear side (two times 25.7 g/m² add-on, meaning two times 7.1 g/m² PVAm), emissive surface=0.12 m².

### Results:

| | | Formaldehyde | Formaldehyde |
|---|---|---|---|
| | | Area | concentration |
| | | Specific | in |
| | | Emission | reference |
| | | Rate SER | room-Ceiling |
| | Days | (μg/m\hat{ }2.h) | (μg/m\hat{ }3) |
| Wood based panel | 2 | 160.4 | 128.3 |
| (WBP) | 7 | 152.8 | 122.2 |
| WBP + NS Veil | 2 | 161.1 | 128.9 |
| | 7 | 169.1 | 135.3 |
| WBP + Recipe 1/ × 12 g | 2 | 17.3 | 13.8 |
| | 7 | 22.1 | 17.7 |
| WBP + Recipe 1/ × 25 g | 2 | 10.4 | 8.3 |
| | 7 | 13.4 | 10.7 |
| WBP + Recipe 1/ × 25 g | 2 | 2.3 | 1.8 |
| 2 sides | 7 | 8.0 | 6.4 |

The results show that each of the Recipe 1 WBP panels had significantly reduced formaldehyde emissions than the unfaced/untreated wood panel and the non-scavenging veil. In particular, the WBP+Recipe 1/x25g² sides product achieved excellent results.

Further testing showed that the WBP+Recipe 1/x25g² sides product had formaldehyde emissions of <10 ug/m\hat{ }3 at 28 days.

### Examples 2 and 3

In this example, a wood based panel was used as a formaldehyde emission source. The rear side and edges of the panel were covered with a non-emissive aluminium tape. The emitting surface was about 0.06 m\hat{ }2 in a 51 L chamber. Formaldehyde concentrations (μg/m\hat{ }3) are given as estimation in the European standard room, considering Ceiling loading factor.

The “Recipe 2” scavenger formulation (Example 2) used on the scavenging veils was:

| Component | Solids (%) | Kg wet | Kg dry |
|---|---|---|---|
| anti-foam | 0.5% | 8.1 | 0.01% |
| ATH fire retardant | 68.0% | 322.1 | 69.73% |
| base | 7.5% | 450.9 | 10.77% |
| scavenger (PVAm) | 21.0% | 161.0 | 10.77% |
| acrylic binder | 50.0% | 49.9 | 7.95% |
| repellent | 30.0% | 8.1 | 0.77% |

The “Recipe 3” scavenger formulation (Example 3) used on the scavenging veils was:

| Component | Solids (%) | Kg wet | Kg dry |
|---|---|---|---|
| anti-foam | 0.5% | 8.1 | 0.01% |
| ATH fire retardant | 68.0% | 324.7 | 70.28% |
| base | 7.5% | 454.5 | 10.85% |
| scavenger (PVAm) | 21.0% | 162.3 | 10.85% |
| acrylic binder | 50.0% | 50.3 | 8.01% |

### Samples:

Wood Based Panel (WBP): unfaced wood panel
WBP+A: wood panel+1 scavenging veil applied on the surface (Recipe 2, 45 g/m² add-on, meaning 4.9 g/m² PVAm)
WBP+B: wood panel+1 scavenging veil applied on the surface (Recipe 3, 45 g/m² add-on, meaning 4.9 g/m² PVAm)
WBP+NS Veil: wood panel+1 non-scavenging veil applied on the surface

### Results:

| | | | Formaldehyde |
|---|---|---|---|
| | | | concentration |
| | | | in |
| | | | reference |
| | | SERA | room- |
| | | form | Ceiling |
| | Days | (μg/m\hat{ }2.h) | (μg/m\hat{ }3) |
| Ref-Wood based | 7 | 138.1 | 110.5 |
| panel (WBP) | | | |
| WBP + A | 7 | <QL | <QL |
| WBP + B | 7 | <QL | <QL |
| WBP + NS Veil | 7 | 183.6 | 147 |

QL = quantification limit. For the reference room, the quantification limit is 0.3 μg/m\hat{ }3 (SERA form: approximately 0.4 μg/m\hat{ }2.h).

The results show that the panels with veils using the Recipe 2 and Recipe 3 formulations had very significantly reduced formaldehyde emissions compared to the unfaced/untreated wood panel and the non-scavenging veil (NS Veil).

In particular, since the formaldehyde emissions from the panels with veils using the Recipe 2 and Recipe 3 formulations could not be quantified, and since the rate of emissions decreases over time, it can be concluded that after 28 days the formaldehyde emissions at 28 days will be <10 ug/m\hat{ }3.

### Example 4

In this example, a formaldehyde scavenger formulation is as follows:

| Component | Solids (%) | Kg wet | Kg dry |
|---|---|---|---|
| anti-foam | 0.5% | 5.6 | 0.01% |
| ATH fire retardant | 68.0% | 658.8 | 89.25% |
| base | 7.5% | 110.0 | 1.64% |
| scavenger (PVAm) | 21.0% | 74.8 | 3.13% |
| acrylic binder | 50.0% | 59.9 | 5.96% |

With this, scavenger (i.e. the formulation) is added to a veil as follows:

| | |
|---|---|
| Scavenger (g/m²) | 4.38 |
| Total add-on (including scavenger) (g/m²) | 140 |

### Example 5

In this example, a formaldehyde scavenger formulation is as follows:

| Component | Solids (%) | Kg wet | Kg dry |
|---|---|---|---|
| anti-foam | 0.5% | 5.6 | 0.01% |
| ATH fire retardant | 68.0% | 654.4 | 88.21% |
| base | 7.5% | 109.3 | 1.62% |
| scavenger (PVAm) | 21.0% | 74.4 | 3.10% |
| acrylic binder | 50.0% | 59.5 | 5.90% |
| repellent | 30.0% | 9.9 | 0.59% |
| cross-linker | 45.0% | 6.5 | 0.58% |

With this, scavenger (i.e. the formulation) is added to a veil as follows:

| | |
|---|---|
| Scavenger (g/m²) | 4.34 |
| Total add-on (including scavenger) (g/m²) | 140 |

### Example 6

In this example, a formaldehyde scavenger formulation is as follows:

| Component | Solids (%) | Kg wet | Kg dry |
|---|---|---|---|
| anti-foam | 0.5% | 12.7 | 0.02% |
| ATH fire retardant | 68.0% | 580.8 | 93.41% |
| base | 7.5% | 90.7 | 1.61% |
| scavenger (PVAm) | 21.0% | 65.3 | 3.25% |
| acrylic binder | 50.0% | 14.5 | 1.72% |

With this, scavenger (i.e. the formulation) is added to a veil as follows:

| | |
|---|---|
| Scavenger (g/m²) | 3.67 |
| Total add-on (including scavenger) (g/m²) | 113 |

### Example 7

| Component | Solids (%) | Kg wet | Kg dry |
|---|---|---|---|
| anti-foam | 0.5% | 67.3 | 0.21% |
| base | 7.5% | 480.6 | 22.24% |
| scavenger (PVAm) | 21.0% | 346.1 | 44.85% |
| acrylic binder | 50.0% | 106.0 | 32.70% |

With this, scavenger is added to a veil as follows:

| | |
|---|---|
| Scav (g/m²) | 4.48 |
| Total add-on (including scavenger) (g/m²) | 10 |

### Example 8 (Reference Example)

In this example, a wood based panel was used as a formaldehyde emission source. The back (rear) side and edges of the panel were covered with a non-emissive aluminium tape. The emitting surface was about 0.06 m\hat{ }2 in a 51 L chamber. Formaldehyde concentrations (μg/m\hat{ }3) are given as estimation in the European standard room, considering Ceiling loading factor.

The “Recipe 4” scavenger formulation used on the scavenging veil was:

| Component | Solids (%) | Kg wet | Kg dry |
|---|---|---|---|
| scavenger (aminosilane) | 58.0% | 100 | 100.000% |

Water was added to arrive at a composition (i.e. formulation) suitable for the application method and needed dry add on.

### Samples:

Wood based panel (WBP): unfaced wood panel
WBP+Recipe 4: wood panel+1 scavenging veil (pure scavenger, 9 g/m\hat{ }2 add-on, meaning 9 g/m\hat{ }2 scavenger)

### Results:

| | | | Formaldehyde |
|---|---|---|---|
| | | | concentration |
| | | | in |
| | | | reference |
| | | SERA | room- |
| | | form | Ceiling |
| | Days | (μg/m\hat{ }2.h) | (μg/m\hat{ }3) |
| Ref-Wood based | 7 | 164.2 | 131.36 |
| panel (WBP) | | | |
| WBP + Recipe 4 | 7 | 95 | 76 |

The results show that the panels with veils using the aminosilane achieved good results as compared to the reference WBP. This indicates that aminosilane is suitable for use as a formaldehyde scavenger.

### Example 9

In this example, a formaldehyde scavenger formulation is as follows:

| Component | Solids (%) | Kg wet | Kg dry |
|---|---|---|---|
| anti-foam | 0.5% | 26.0 | 0.01% |
| ATH fire retardant | 60.0% | 3392.0 | 87.53% |
| base | 15.0% | 350.0 | 2.26% |
| scavenger (PVAm) | 21.0% | 340.0 | 3.07% |
| acrylic binder | 50.0% | 272.0 | 5.85% |
| repellent | 30.0% | 50.0 | 0.65% |
| cross-linker | 45.0% | 33.0 | 0.64% |

Improved formaldehyde scavenging results were obtained as compared to reference WBP.

Various modifications and variations to the described embodiments of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes of carrying out the invention which are obvious to those skilled in the art are intended to be covered by the present invention.

1. A formaldehyde-scavenging formulation comprising:
(a) formaldehyde scavenger (1-90% by weight dry mass), wherein the formaldehyde scavenger is polyvinylamine or a copolymer thereof, and/or a primary amine functionalised silane;
(b) binder and/or crosslinker (<=60% by weight dry mass); and
(c) antifoaming agent (<0.5% by weight dry mass);
and at least one of:
(d) base (<=50% by weight dry mass);
(e) fire retardant (<=96% by weight dry mass); and
(f) repellent agent (<2% by weight dry mass).

2. A formaldehyde-scavenging formulation according to claim 1, comprising base (<=50% by weight dry mass).

3. A formaldehyde-scavenging formulation according to claim 2, comprising base in the range 0.5-25% by weight dry mass.

4. A formaldehyde-scavenging formulation according to claim 1, additionally comprising at least one of:
(A) dispersing agent;
(B) viscosity modifier; and
(C) polyphosphate sodium salts (NaPO₃)ₙ.

5. A formaldehyde-scavenging formulation according to claim 1, additionally comprising pigment.

6. A formaldehyde-scavenging formulation according to claim 1, wherein the formaldehyde-scavenging formulation is an aqueous formulation.

7. A formaldehyde-scavenging formulation according to claim 1, wherein the fire retardant is selected from the group consisting of: aluminium trihydrate (ATH) and phosphorous nitrogen (P—N) fire retardants

8. A formaldehyde-scavenging formulation according to claim 1, wherein:
the formaldehyde scavenger is present in an amount of 1-50% by weight dry mass, and wherein the formaldehyde scavenger is polyvinylamine;
the binder and/or crosslinker is present in an amount of <=20% by weight dry mass;
the fire retardant is present in an amount of 50-96% by weight dry mass, and wherein the fire retardant is a phosphorous-nitrogen fire retardant; and
the repellent agent is present in an amount of <2% by weight dry mass.

9. A formaldehyde-scavenging formulation according to claim 1, wherein:
the formaldehyde scavenger is present in an amount of 1-50% by weight dry mass, and wherein the formaldehyde scavenger is polyvinylamine;
the binder and/or crosslinker is present in an amount of <=20% by weight dry mass; and
when present, the base is included in an amount of <=12.5% by weight dry mass; and
when present, the fire retardant is included in an amount of 50-96% by weight dry mass, and is an aluminium trihydrate fire retardant.

10. A formaldehyde-scavenging formulation according to claim 1, wherein:
the formaldehyde scavenger is polyvinylamine;
the binder and/or crosslinker is present in an amount of <=50% by weight dry mass; and
the base is present in an amount of <=25% by weight dry mass.

11. A formaldehyde-scavenging formulation according to claim 1, wherein the polyvinylamine (PVAm) has a weight average molecular weight (Mw) in the range 50,000-800,000 g/mol.

12. A non-woven veil coated with or containing a formaldehyde-scavenging formulation according to claim 1.

13. A non-woven veil coated with or containing an aminosilane.

14. A non-woven veil according to claim 12, wherein the veil is a glass fibre non-woven veil.

15. A construction product having a non-woven veil according to claim 12 on at least one surface.

16. A construction product according to claim 15, wherein the construction product is made of a wool selected from the group consisting of: glass wool, rock wool, stone wool and mineral wool.

17. A construction product according to claim 15, wherein the construction product is selected from the group consisting of: a ceiling tile, a wall panel, an insulation board, and a wood based panel.

18. A method of reducing formaldehyde emissions from a construction product, the method comprising the step of attaching a non-woven veil according to claim 12 to at least one outer surface of the construction product.
